(19) United States
(12) Patent Application Publication
(10) Pub. No.: US 2016/0360699 A1
(43) Pub. Date: Dec. 15, 2016

(54) CONVEYOR BELT TENSING APPARATUS FOR A HARVESTING HEADER

(71) Applicant: Jose Luis Allochis, Buenos Aires (AR)

(72) Inventor: Jose Luis Allochis, Buenos Aires (AR)

(21) Appl. No.: 14/735,196

(22) Filed: Jun. 10, 2015

(51) Int. Cl. A01D 43/06; A01D 41/14; B65G 23/44

(52) U.S. Cl. CPC A01D 43/06; B65G 23/44; A01D 41/14

(57) ABSTRACT

The invention relates to a header with a belt tensioner that accommodates the flexing and twisting of the conveyor belts and generates a constant tension evenly distributed across the width of the conveyor belts.

### FIELD OF THE INVENTION

The present invention relates to harvesting platforms of the type that are carried on the front end of an agricultural combine. More specifically, it relates to conveyor belt tensioners for agricultural harvesting headers.

### BACKGROUND OF THE INVENTION

An agricultural harvesting machine such as a combine tractor generally includes a harvesting front attachment mounted onto a feeder or crop elevator. The front attachment gathers the crop material from the field while the feeder directs it to a threshing separating and cleaning mechanism located in the combine to produce grains. The process further completes when those grains are sent from the combine to the next step of the production chain selected for this type grain.

For low growing, thin stemmed crops such as soybeans, barley, wheat, bean, etc., the header driven by the combine has a reciprocating knife at the leading edge called cutterbar. The crop is cut using the cutterbar and falls forward onto laterally extending conveyor that carry the crop to a central section of the header. This laterally extending conveyor is preferably a belt conveyor, usually called draper conveyor.

The header is mounted to the combine tractor at open end. The crop material travels laterally by means of the draper conveyor and passes then through this open end to the feeder of the combine.

The draper conveyor generally consist of two side belt conveyors, one on each side of the platforms open end. Each side belt conveyor normally comprises a closed loop belt wrapped around two rollers. Generally, one of this inner rollers is set to work as a driver and the other as an idler.

To grant the friction that allows the belts to be driven, they must be tensioned to create the proper pressure against the corresponding idler and drive rollers. Sufficient tension must be maintained across the width of the rollers so that they can transfer required power to the belt to carry the crop.

In modern design flexible draper platforms, the cutterbar assembly is forced to go up and down and curl to assimilate the contour of the ground; the draper conveyor behind the cutterbar is forced to flex therewith.

Accommodating the flexing and twisting of the conveyor belts is difficult using traditional belt tensioners. The rollers must be able to push outward against the belt and also pivot side to side to distribute the tension across the belt. Tension on the belts may result inconstant and widely varying, thus resulting into belt breakages, slippages, or belts that may suffer premature wear.

It is an object of this invention to provide a header with a belt tensioner that accommodates the flexing and twisting of the conveyor belts and generates a constant tension evenly distributed across the width of the conveyor belts.

### DESCRIPTION OF THE DRAWINGS

FIG. 1 is a top front perspective view illustrating a platform in accordance with the present invention.

FIG. 2 is a bottom front perspective view of the platform shown in FIG. 1.

FIG. 3 is a top rear perspective view of the platform shown in FIG. 1.

FIG. 4 is a top front perspective fragmentary view of the platform shown in FIG. 1 showing the tail rollers.

FIG. 5 is a fragmentary front view of the platforms shown in FIG. 1, with the draper belts being cut open to show the belt tension mechanism.

FIG. 6 is a top fragmentary view of the belt tensioning mechanism supporting the head rollers where the draper belt where removed for clarification purposes.

FIG. 7 is a top fragmentary view of the belt driving mechanism supporting the tail rollers where the draper belt where removed for clarification purposes.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE EMBODIMENT

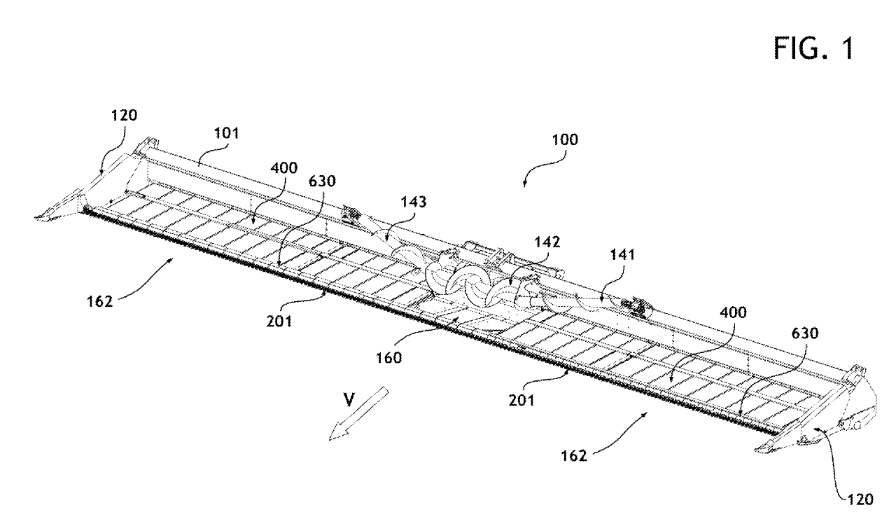

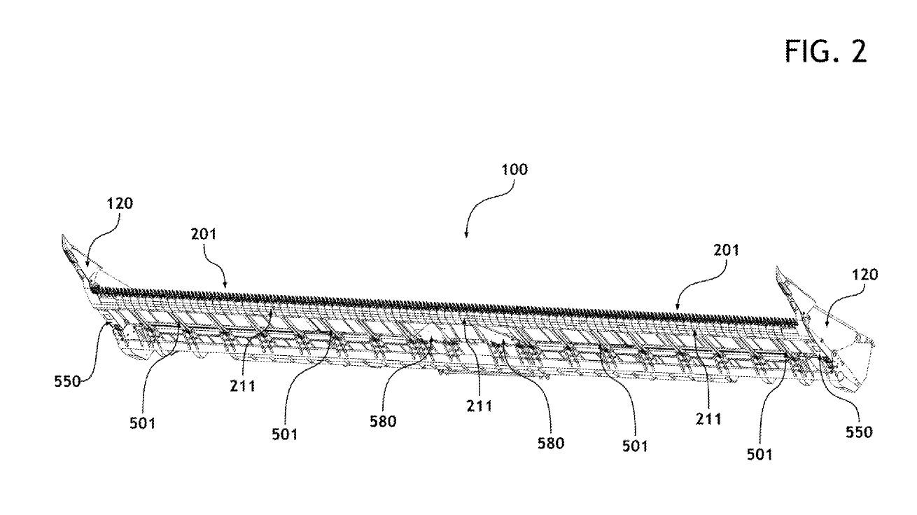

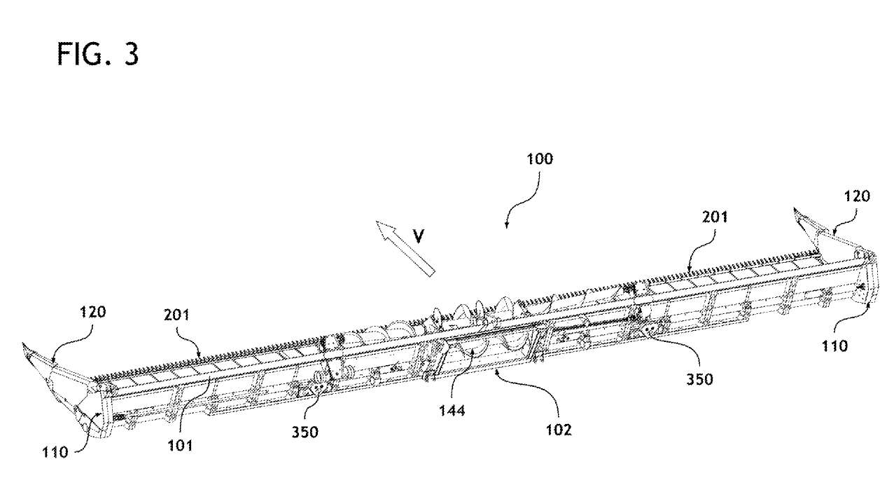

Referring to FIGS. 1-3, the harvest header selected for illustration comprises a flexible platform 100 used in agricultural machines, preferably combine tractors. The platform 100 is configured to cut and harvest the crop while is advanced in a direction V generally forward so that the material is conveyed to an open end 102 and subsequently processed by other elements (not shown) of the combine tractor (not shown) to finally produce grains.

The platform 100 illustrated generally includes a main frame 101 comprising a central section 160 which projects forwardly from the open end 102, and at least two side sections 162 projecting laterally on either side of said central section 160. All the sections 160, 162 are bounded forwardly by the cutterbar assembly 201 and at the rearward by the main frame 101. Inside side sections 162 there is a set of belt support arms 501 responsible for a holding the cutterbar assembly 201 and responsible for sustain partially the set of belts of a draper conveyor 400. Draper conveyors 400 are responsible for transporting the cut crop from the side sections 162 to the center section 160. The outer lateral limits of the side sections 162 are each defined by a side arm 550, which is configured as the outermost point of support of the cutterbar assembly 201, and is responsible for carrying the transmission mechanism for driving said cutterbar 201. The portion of the cutterbar 201 which corresponds to the central section 160 is supported by at least one central arm 580, thus conferring to the platform 100 the property that its cutterbar assembly 201 is completely flexible, from end to end, from the outer side end of a side section 162 to the outer side end of the other side section 162. The platform 100 also contains a central auger assembly 140 comprising a right oblique auger 143, a left oblique auger 141, a front central auger 142 and a rear central auger 144; furthermore, contains a reel (not shown) extending laterally almost the full width of the platform 100 that operates to push inward standing crop platform 100. Both of the cutterbar assembly 201 and the draper conveyor 400 are preferably flexible so that the platform can work virtually 100 attached to the floor and adapt to the changing curved profile of the terrain when operated through the working direction V.

The platform 100 cited in the present invention is configured such that when advanced in the direction V, it erects and directs the crop with the reel (not shown) towards the draper conveyors 400 while cutting it via the cutterbar assembly 201. The cut crop falls onto the draper conveyor 400 and is carried to the central section 160 of the platform 100, where the set of augers 140 finally pushes it across the open end 102 to be subsequently treated by a threshing machine (not shown).

### Belt Tensioning Mechanism

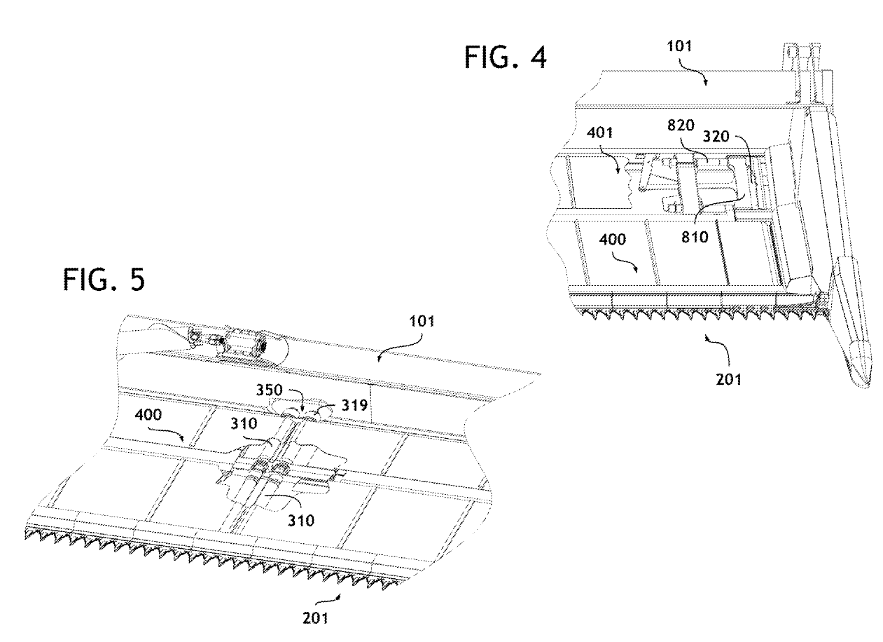

Referring to FIGS. 4 to 7 show a preferred configuration for the draper conveyor.

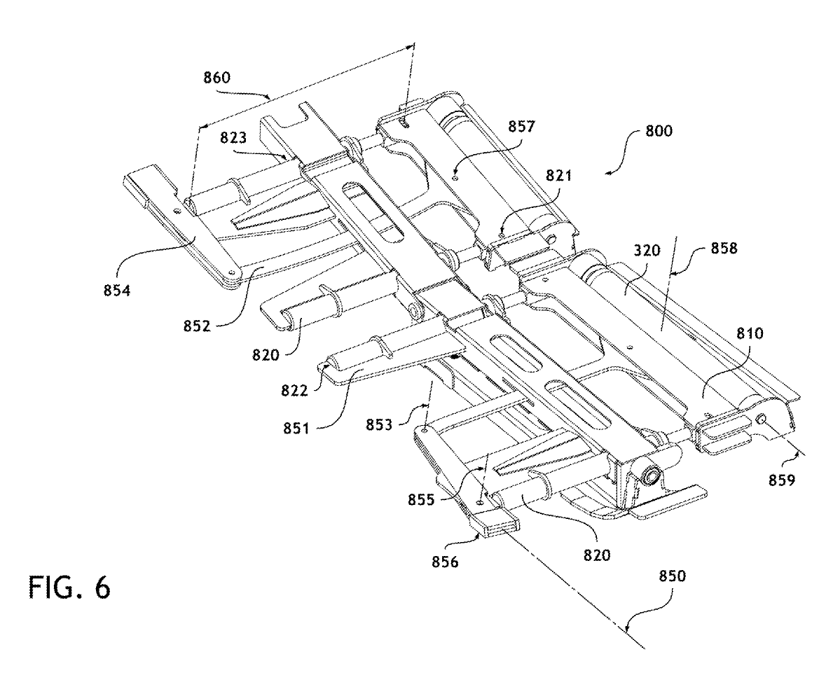

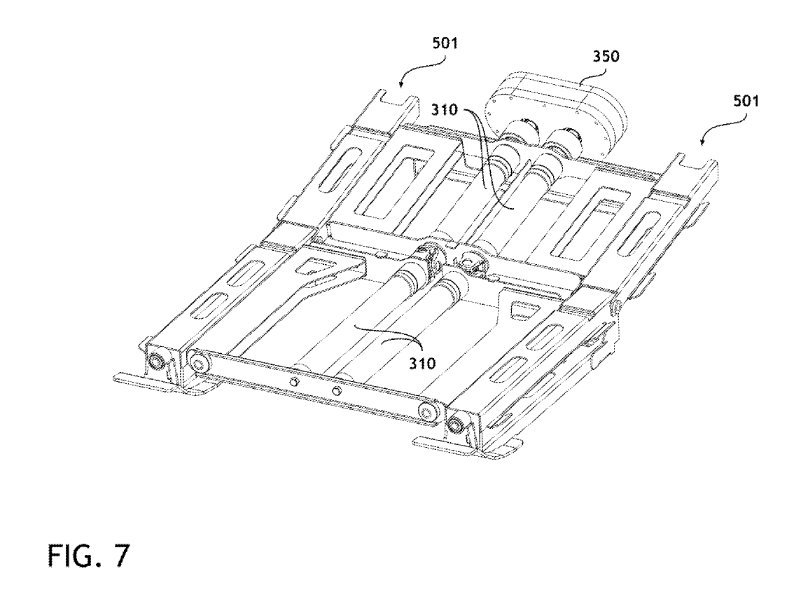

The conveyor belts 400 are disposed on said plurality of arms 501 to carry cut crop material. The conveyor belts 400 are supported on several idler 320 and drive 310 rollers that in turn are supported on several of the arms 501. These rollers pivot up and down together with the arms 501 on which they are mounted. These rollers support the loops at the ends of conveyor belts and keep the proper tension in the conveyor belts. The rollers permit the conveyor belts to pivot up and down and twist as the underlying arms move up and down with respect to each other (FIG. 6 and FIG. 7).

The tensioning mechanism 800 is mounted on an arm 501 to tension respective draper conveyor 400 (FIG. 6). Tensioning mechanism 800 stretches the conveyor belt 400 by applying force to an idler roller 320, which in turn presses against the corresponding driver roller 310 (FIG. 7) to tension the conveyor belt thereby keeping the conveyor belt under sufficient tension to maintain its proper position on rollers 310, 320.

Tensioning mechanism 800 includes a translating roller carriage 810, at least one gas spring 820, and a crank-rod mechanism. Gas springs 820 are hydro-pneumatic springs that applies nearly constant force through their entire stroke.

Gas springs 820 are mounted onto hollow cavities 823 in the arms 501, limited at the rear end 822 by a stop plate 851. Thus the gas spring 820 moves together with the arm 501 when it pivots about corresponding axis. In a preferred embodiment no locking or securing is set to the gas springs 820, mounted loose free, thus gas springs 820 are free to be removed by pulling them away from stop plate 851 when the closed loop draper conveyors 400 is not present.

Roller carriage 810 is fastened to the front end 821 of a gas spring 820. In a preferred configuration, each roller carriage presents forward and rearward ends. The tensioning mechanism 800 comprises two gas springs 820 (FIG. 6), each one mounted into an arm 501 by its rear ends and each one being connected to said forward and rearward ends of the roller carriage 810. Thus, no external guide member is needed in this configuration. Gas springs 820 rods move forward and rearward in a direction parallel to the travel direction of the draper conveyors 400 and perpendicular to the direction of travel “V” of the draper header 100. Both gas springs 820 are disposed such that they are parallel with each other and intersect the rotational axis 859 of the idler roller 320, thus the idler roller 320 displaces always over a plane surface.

Gas springs 820 coupled to opposite ends of the roller carriage 810 permit the idler roller 320 to twist slightly about the axis 858 as the arms 510 pivot up and down. When the arms 510 are pivoted up and down in different directions with respect to each other, it causes the leading edge of the conveyor belt 400 to have a similar up-and-down shape (and therefore causing a linear length shrink of the belt at the leading edge). The rear (or trailing) edge of the conveyor belt 400 does not have the same up-and-down shape since the trailing edge of the conveyor is closer to the pivot axis of the arms 501. Consequently, the tension along the front edge of the conveyor belt 400 tend to increase significantly more than the belt tension along the rear edge of the conveyor belt 400. To cancel this tension difference on the front of the belt 400 yet maintain the relatively unchanged tension on the rear of the belt 400, the front end of the idler roller 320 must be permitted to translate toward the driver roller 310 (which supports the other end of conveyor belt 400) more than the rear of the conveyor belt.

This reduction of linear length at the front end of the roller but not at the rear end is provided by one of the constant force gas springs 820 stroking in and allowing the idler roller 320 to pivot slightly about axis 858 as the belt flexes up and down more in the front than in the rear. The pivoting of the roller about 858 only affects the stroke lengths 860, causing the stroke length 860 of the gas spring 820 at the front of the belt being less than the stroke length 860 of the gas spring 820 at the rear of the belt. Moreover, as each gas spring 820 has a nearly constant force-displacement characteristic curve, the shrinking of the linear length of the leading edge of the conveyor belt 400 is absorbed at constant force. This guarantees that the forces pushing at front and rear ends of the idler roller 320 are always equal and constant, causing a constant homogeneous pressure to the belt 400.

The tension in onto the draper conveyors 400 is unmanaged and automatically gained without the intervention of the user. Gas springs 820 keep a generally constant force regardless the changes on the distance between rollers 310, 320. Tension can be raised or lowered by replacing the gas springs 820 for other gas springs with different gas loads. Tension achieved by the tensioning mechanism 800 is always constant, disregarding the variations on the belts (id est stress), which happens due to changes in temperature, aging, moisture or variations in loads, among others.

The tension onto the draper conveyors 400 can be removed driving the crank-rod mechanism (FIG. 6). Crank 854 present forward and rearward ends, and is rotary mounted to an arm 501. By inserting the lever (not shown) into the cavity 856 at the rearward end of the crack 854, the axis 850 of the crack 854 can be forced to rotate around the mounting axis 855, and thus the forward end of the crank 854 can pivot in the opposite direction to the rearward end.

The forward end of the crank 854 is linked to one end of a connecting rod 852. The other end of the connecting rod 852 is coupled to the translating roller carriage 810. Then, to (a) remove the belts, the user operates the crack 854 and applies a lock (not shown) that holds the gas springs 820 retracted. Once the belts get re-installed, to (b) reach the operating tension back the operator just have to release the lock; no other extra step is necessary, the force on the belts is automatically achieved.

The preferred forms of the invention described above are to be used as illustration only, and should not be utilized in a limiting sense when interpreting the scope of the present invention. Some alterations to the exemplary embodiments described above could be readily made by those skilled in the art without departing from the spirit of the present invention.

The inventor hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. An agricultural header used to harvest crops, said header operable to be supported at an open end that is configured to receive severed crop materials, said header comprising:
a main frame (101) operable to be mounted to the open end (102), said main frame comprising a central section (160) located adjacent to said open end, and comprising right and left lateral sections (162) at the sides of said central section extending transversely with respect to the normal direction of travel (V) of the platform;
a plurality of arms (501) pivotally coupled to the frame (101) to pivot up and down at their forward ends with regard to said frame (101) and extending forward from said frame (101);
a cutterbar assembly (201) to extend lengthwise through said lateral and central regions; said cutterbar assembly being operable to flex along the length thereof in response to changes in terrain as the platform is advanced;
a draper conveyor assembly (400) comprising lateral belt conveyors disposed behind the cutterbar assembly to flex therewith; said draper conveyor assembly being supported on the lateral sections (162) to convey cut crop material laterally inwardly toward the central section (160); and
at least one belt tensioning mechanism (800) in each lateral belt conveyors, each belt tensioning mechanism comprising:
a roller (320) comprising a front end and a rear end and a central axis (859), wherein the lateral conveyor belt is wrapped around the roller (320) for approximately 180 degrees to form an end loop in said lateral conveyor belt;
an elongate roller carriage (810) being configured to support the roller (320) for rotation about the central axis (859); and
at least one linear actuator (820) comprising a front end and a rear end, wherein the rear end is mounted onto one of said arms (501), wherein the front end is coupled to the elongate roller carriage (810) to apply pressure to the elongate roller carriage (810), and
wherein the linear actuator (820) is characterized because it is a hydro-pneumatic gas spring with a nearly constant force-displacement characteristic curve.

2. The agricultural header according to claim 1,
wherein said elongate roller carriage (810) presenting inner and outer ends, wherein the outer end of the elongate roller carriage (810) is configured to hold roller (320), and
wherein the front end of the linear actuator (820) is pivotally coupled to the inner end of the elongate roller carriage (810).

3. The agricultural header according to claim 1,
said one arm (501) presenting transversely a hollow cavity (823);
said linear actuator (820) being inserted into the hollow cavity (823).

4. The agricultural header according to claim 1,
said roller carriage (810) presenting front and rear ends;
said belt tensioning mechanism (800) comprising another linear actuator (820), wherein the front end of the first linear actuator being connected to the front end of the roller carriage (810) and wherein the second linear actuator being connected to the rear end of the roller carriage (810).

5. The agricultural header according to claim 4,
said roller (320) comprising a normal axis (858) generally perpendicular to the rotational central axis (859);
wherein the rotational axis (859) of the roller is operable to twisting around the normal axis (858) to compensate heterogeneous loads to said roller, and
said twisting movement being permitted by different extension lengths of the corresponding linear actuators (820).

6. The agricultural header according to claim 4,
said roller (320) comprising a normal axis (858) generally perpendicular to the rotational central axis (859);
wherein the rotational axis (859) of the roller is operable to twisting around the normal axis (858) to compensate heterogeneous loads to said roller, and
said twisting movement characterized for being permitted by different extension lengths (860) of the corresponding linear actuators (820).

7. The agricultural header according to claim 4,
wherein each linear actuator (820) comprises an axial axis;
said axial axis being disposed parallel to each other; and
both axial axis being on a plane parallel to the travel direction of the draper conveyor (400).

8. The agricultural header according to claim 1,
wherein said belt tensioning mechanism (800) comprises a retracting apparatus operable to pull the elongate roller carriage (810) inwards to release the tension to the lateral draper conveyor; and
said belt tensioning mechanism (800) further comprising a locking member configured to block the belt tensioning mechanism (800) and retain the linear actuators (820) retracted.

9. A method for operating the agricultural header stated in claim 8, said method comprising the steps of:
operating the retracting apparatus to bring inwards the roller carriage (810), contracting the linear actuator (820);
operating the locking member to block the belt tensioning mechanism (800), keeping the corresponding lateral draper conveyor free from tension; and
operating the locking member to release the block to the belt tensioning mechanism (800), freeing the linear actuator (820) to push outwards; the working tension exerted to the lateral draper conveyor is automatically gained by the linear actuator (820).

10. An agricultural header used to harvest crops, said header operable to be supported at an open end that is configured to receive severed crop materials, said header comprising:
a main frame (101) operable to be mounted to the open end (102), said main frame comprising a central section (160) located adjacent to said open end, and comprising right and left lateral sections (162) at the sides of said central section extending transversely with respect to the normal direction of travel (V) of the platform;
a plurality of arms (501) pivotally coupled to the frame (101) to pivot up and down at their forward ends with regard to said frame (101) and extending forward from said frame (101);
a cutterbar assembly (201) to extend lengthwise through said lateral and central regions; said cutterbar assembly being operable to flex along the length thereof in response to changes in terrain as the platform is advanced;
a draper conveyor assembly (400) comprising lateral belt conveyors disposed behind the cutterbar assembly to flex therewith; said draper conveyor assembly being supported on the lateral sections (162) to convey cut crop material laterally inwardly toward the central section (160);
a first roller (310) supporting a first end loop of a lateral conveyor belt for reversing the direction of said lateral conveyor belt, said first roller (310) being supported on a first one of said plurality of arms (501); and
at least one belt tensioning mechanism (800) in each lateral belt conveyors, each belt tensioning mechanism comprising:
a second roller (320) comprising a front end and a rear end and a central axis (859), wherein the lateral conveyor belt is wrapped around the second roller (320) for approximately 180 degrees to form a second end loop in said lateral conveyor belt;
an elongate roller carriage (810) being configured to support the roller (320) for rotation about the central axis (859); and
at least one linear actuator (820) comprising a front end and a rear end, wherein the rear end is mounted onto one of said arms (501), wherein the front end is coupled to the elongate roller carriage (810) to apply pressure to the elongate roller carriage (810), and
wherein the linear actuator (820) is characterized because it is a hydro-pneumatic gas spring with a nearly constant force-displacement characteristic curve.
